(19) United States
(12) Patent Application Publication
(10) Pub. No.: US 2002/0089967 A1
(43) Pub. Date: Jul. 11, 2002

(54) Recovery of the initial packet transmitted by a terminal in a packet transmission system with a return channel

(76) Inventors: Americo Brajal, Villeneuve le Roi (FR); Delphine Legrand, Paris (FR); Antoine Chouly, Paris (FR)

Correspondence Address: U.S. Philips Corporation, 580 White Plains Road, Tarrytown, NY, 10591, US

(21) Appl. No.: 10/015,854

(22) Filed: Nov. 30, 2001

(30) Foreign Application Priority Data
Dec. 5, 2000 (FR) 0015754

(51) Int. Cl. H04B 7/212; H04J 3/24

(52) U.S. Cl. 370/347; 370/349

(57) ABSTRACT

The invention relates to an interactive packet transmission system of the TDMA type with a return channel between terminals and a network head. The invention proposes a method of recovering the first packet transmitted by a terminal for connection to the system, in accordance with which the transmitted data are searched by performing successive correlations in variable computing windows along the received packet by using a known header. The correlation computations are solely performed on the optimal oversamples, while the estimation of the initial sampling instant is previously effected for each window considered.

The invention relates to a receiver for a packet transmission system of the TDMA type comprising at least a terminal suitable for transmitting, to the receiver, a packet of symbols, referred to as transmitted packet, in a time interval allocated in accordance with a predetermined allocation plan, said transmitted packet comprising a useful part and a known header, the receiver comprising:

means for receiving a packet of symbols, referred to as received symbols, corresponding to the allocated time interval,

oversampling means for generating oversamples from a received symbol, and

means for recovering said transmitted packet for retrieving the position of the transmitted packet in the allocated time interval.

The invention also relates to a packet transmission system comprising such a receiver.

The invention also relates to a receiving method for determining the position of a packet of symbols, referred to as transmitted packet, the system comprising useful data and a known header transmitted by a terminal of a packet transmission system of the TDMA type within a time interval allocated in accordance with a predetermined allocation plan, the method comprising the steps of:

receiving a packet, referred to as received packet, corresponding to the allocated time interval and comprising symbols, referred to as received symbols, among which is the transmitted packet,

oversampling for generating oversamples from said received symbols,

shifting for selecting a variable computing window in the received packet,

searching the optimal sampling instant for selecting, on the basis of the generated oversamples, the optimal oversamples corresponding to the received symbols comprised in the current window, and

successive correlations in the current window between the selected oversamples and the known header of the transmitted packet, and

decision for detecting the presence of the transmitted packet in a computing window and for deriving its position within the allocated time interval.

The invention further relates to a computer program comprising instructions provided for performing the above-mentioned method, as well as to a signal which is capable of transmitting these instructions for performing the method.

The invention finds important applications in the field of satellite or cable transmission and particularly in transmissions with a return channel in which a plurality of terminals are suitable for transmitting data packets to a network head in accordance with a time division mechanism. It relates particularly to systems which are compatible with a standard of the DVB-RCS type (Digital Video Broadcasting-Return Channel via Satellite), such as the recommendation published under the reference “DVB blue book A54 rev. 1” as well as systems in accordance with the ETSI recommendation (European Telecommunication Standards Institute), currently still in an approval phase under the reference “Draft ETSI EN 301 790 V. 1.2.1” in its version of July 2000.

In the interactive satellite systems, several terminals can transmit signals to one and the same receiver, referred to as network head, by using an ascending connection, or return channel. In accordance with the modes of allocating and dividing the resources used in the return channel, the recovery at the level of the receiver/network head of data transmitted by the different terminals pose different problems. In the example of the time division systems in accordance with the above cited DVB-RCS standard, the entrance to a new terminal in the system is effected by the transmission of a first data packet, referred to as CSC (Common Signaling Channel), in the ascending channel in a time interval allocated for this purpose in accordance with a predetermined allocation plan. However, taking numerous time, frequency and power errors which may occur during transmission into account, it is not unlikely that the packet is not exactly transmitted in the initially envisaged time interval. To avoid loss of this packet, the time intervals allocated for the return channel are provided with important guarding intervals so as to guarantee a sufficient error margin during the transmission of the packet. At the receiving end it is necessary to retrieve the exact position of the packet transmitted within the time interval so as to recover the useful data. The correct recovery of this first packet is all the more necessary as it is a condition for establishing the connection between the terminal and the network.

It is a particular object of the invention to allow a very rapid recovery with a small complexity of computations of the first packets transmitted by a terminal when its connection with the network head of the system is being established.

To this end, the invention relates to a receiver as described in the opening paragraph, which is characterized in that the recovery means comprise:

shifting means for selecting a variable computing window in the allocated time interval,

means for searching the optimal sampling instant for determining, on the basis of the generated oversamples, the optimal oversamples corresponding to the received symbols comprised in the current computing window,

means for successively correlating the optimal oversamples in the current computing window with the known header of the transmitted packet, and

decision means for detecting the presence and position of the transmitted packet in one of the computing windows as a function of the result of the successive correlations.

These and other aspects of the invention are apparent from and will be elucidated, by way of non-limitative example, with reference to the embodiment(s) described hereinafter.

In the drawings:

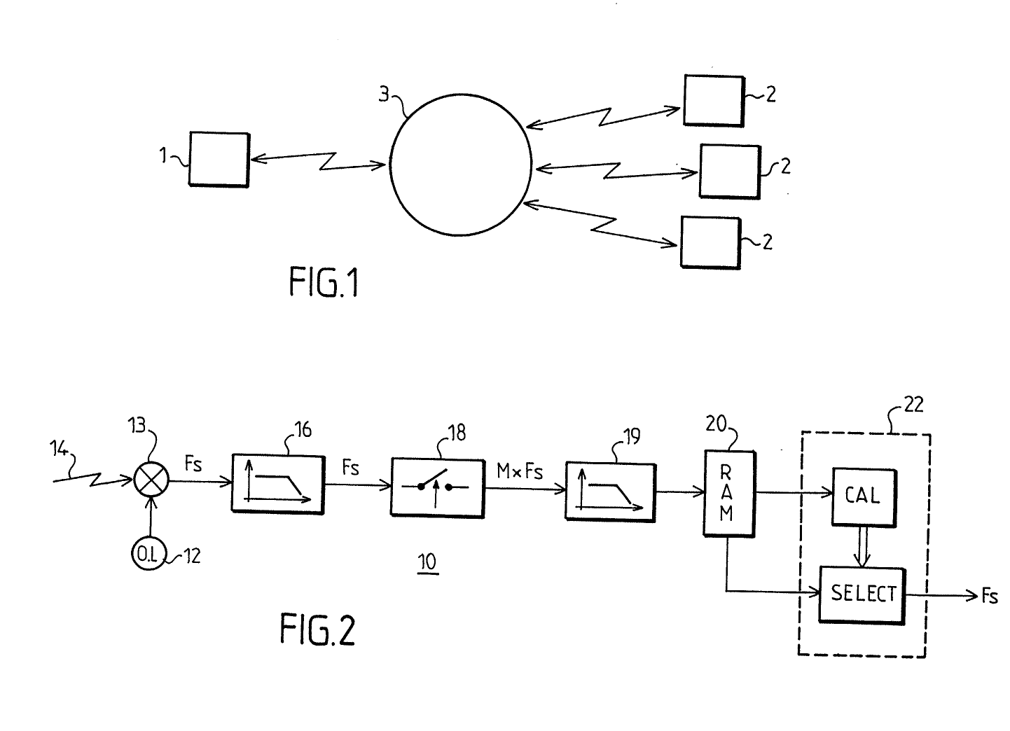

FIG. 1 is a diagram of an embodiment of the transmission system according to the invention,

FIG. 2 is a general diagram of an embodiment of a receiver according to the invention,

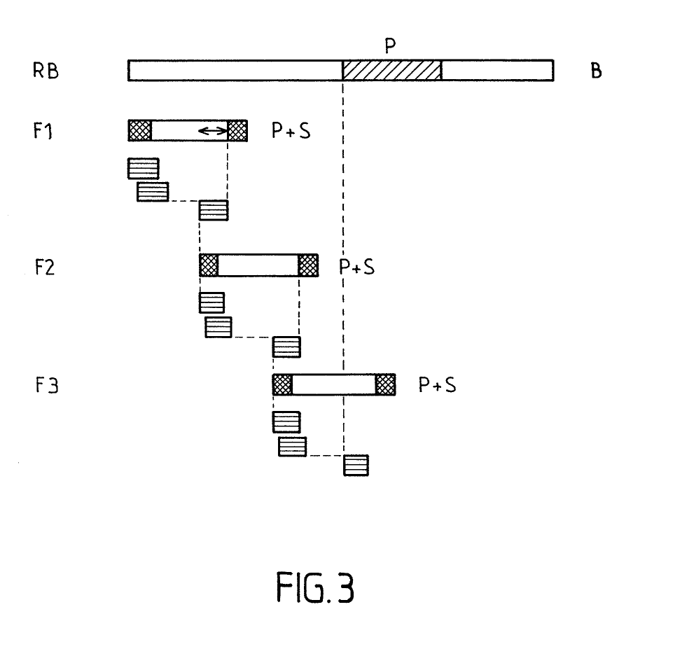

FIG. 3 is a diagram illustrating an embodiment of the invention,

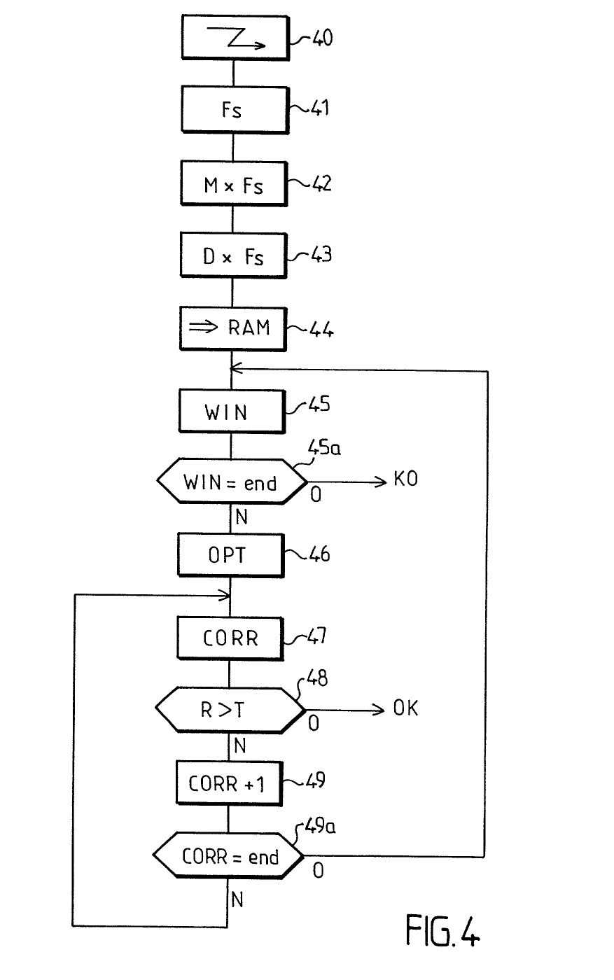

FIG. 4 is a flow chart showing an embodiment of the method according to the invention.

A transmission system according to the invention is shown by way of example in FIG. 1. It comprises a network head 1 and a plurality of interactive terminals 2 which are suitable for transmitting and receiving data to and from the network head by using a transmission medium 3. The transmission medium 3 may be of different kinds: cable, radio, satellite, etc. The transmissions from the terminals to the network head are qualified as ascending transmissions or return channels. The transmissions from the network head to the terminals are qualified as descending transmissions. In the ascending transmissions, the network head 1 has the function of a receiver. In the descending transmissions, each terminal 2 has the function of a receiver. The access of the terminals to the transmission medium is effected, for example, by using a TDMA mechanism (Time Division Multiple Access) possibly combined with an FDMA frequency division (Frequency Division Multiple Access).

In a time division packet transmission system, data packets or symbols may be transmitted in consecutive time intervals, allocated in accordance with a predetermined allocation plan, by different terminals to one and the same receiver, particularly referred to as network head in the interactive transmission systems. Since these packets come from different terminals and since their position is not always exactly known, there is a temporal, frequency and power level uncertainty in the packets received by the network head from these terminals. A particular problem presents itself in the first packets transmitted by a terminal for entering the system. Indeed, the errors at the receiving end in these first packets are very sensitive, particularly in the satellite transmission systems, because the position of the terminals is not known to the network head with sufficient precision. However, it is necessary to attempt to recover the first transmitted packet which is a condition for establishing a connection between the terminal and the system. This recovery means that the position of the packet must be exactly determined in the allocated time interval which comprises important guarding intervals for correctly increasing the probability that the transmitted packet is present within the interval.

The different terminals have different sampling instants because their transmission clocks are not synchronous, and for each received packet the optimal sampling instant corresponding to the transmitted packets must also be determined. Moreover, as these clocks may have a certain jitter, two successive packets transmitted by one and the same transmission terminal may not necessarily have the same optimal sampling instant. Moreover, distortions in the channel may provoke a shift upon arrival. For determining the position of the received packet, the network head or the receiver (which may be another terminal in the case of a point-to-point system) must thus effect an oversampling of the received data. The oversampling uses a multiple clock of the theoretical sampling frequency so as to retrieve the sampling instant used at the transmitting end for transmitting the packets. For example, the oversampling frequency may be 16 times higher than the symbol frequency, which means that 16 samples must be extracted during a received symbol, while one of these samples is the optimal sample, i.e. it is placed at the proximity of the instant where the transmitted symbol starts.

A simplified general circuit diagram of a receiver 10 according to the invention is shown in FIG. 2. The receiver comprises a local oscillator 12 and a mixer 13 for transposing the received signal 14 at the symbol frequency Fₛ in such a way that the spectrum of the transposed signal is centered at zero plus or minus a frequency error caused by the fact that the local oscillators used for transmission at the carrier frequencies are not perfect. The transposed signal is subsequently filtered by a rejection filter 16 so as to eliminate the picture frequencies around 2Fp, where Fp is the transmission carrier frequency, as well as other carriers used in the system. The signal obtained at the output of the rejection filter 16 is sampled by an oversampling device 18 with an integral factor of M intended to generate M oversamples, denoted S₀ to S_{M-1} for each symbol of the transposed signal. According to the invention, the oversamples are generated at the frequency MxFₛ with M≧3.

The oversamples are subsequently filtered by means of a low-pass filter 19 intended to filter the samples during a period DxTₛ, where D is the number of symbols in a packet and Tₛ is the duration of a symbol. The samples provided at the output of the filter 19 are stored in a memory 20, denoted RAM in FIG. 2, so as to be processed by a device for recovering the initial packet 22, intended to retrieve the optimal sampling instant corresponding to the transmitted packet, as well as the position of the packet transmitted by the terminal within the received packet, corresponding to the allocated time interval for transmitted the data of the terminal. The number of samples stored in the memory 20 is DxM, where M is the number of oversamples per symbol. They correspond to a duration of DxTₛ.

The device 22 for recovering the initial packet comprises a computing number CAL and a shift member SELECT. The computing member CAL is provided for calculating the optimal sampling instant and for effecting correlations with a known data header intended to retrieve the position of the first packet transmitted by the terminal in the received packet corresponding to the allocated time interval. The shift member SELECT is provided for effecting shifts of the data stored in the memory 20, which means that a variable computation window is selected for the received data in order that the computing member CAL can determine the optimal oversample in each window before performing correlations for retrieving the position of the searched packet header. At the output of the selector SELECT, the data have the symbol frequency Fₛ. For the receiver, the frequency and phase error are to be estimated and the received data are to be decoded. As these steps are independent of the invention, they will not be described in detail.

This embodiment allows treatment of the case where a single packet is transmitted by a terminal in each time interval provided by the allocation plan which is determined by the network head. In the other cases, which will be described in detail hereinafter, where no or, in contrast, several packets are transmitted in the same time interval, slight modifications in the algorithms must be provided, which do not modify the above-described principle at all, notably at the level of the interactions between the selection member SELECT, the memory RAM and the computing member CAL.

The operation of an embodiment of the device for recovering the initial packet 22 is explained in detail with reference to FIGS. 3 and 4. FIG. 3 shows an example of an algorithm for performing the method of recovering the first transmitted packet from the received packet indicated RB and corresponding to the allocated time interval. This example illustrates the ideal case where a single packet has been transmitted by a terminal in the time interval considered. There may also be two other cases. The network head may receive an empty packet, i.e. no terminal has transmitted any data in the time interval, or received a packet comprising more than a single packet transmitted by at least 2 terminals. These other cases necessitate a particular treatment, which will be described in detail below.

The packet received by the network head in accordance with the illustrated example comprises a number B of symbols, of which one part comprising P symbols represented in a shaded rectangle represents the packet transmitted by the terminal. The other data of the received packet (B−P symbols) correspond to the noise because in this example a single packet has been transmitted in the time interval allocated by the network head. These B−P symbols are particularly used for guaranteeing a guarding interval which is sufficient to allow a certain error margin in the position of the packet transmitted by the terminal in the time interval.

According to the invention, the algorithm is first applied to a first window, denoted F1, comprising the P+S first symbols of the packet, and assuming that the searched packet is effectively situated within this window. The S supplementary symbols are intended to mitigate the ambiguity which is inherent in the algorithm used for the correlations. The estimation of the optimal sampling instant with a selection of the optimal oversamples is denoted by a double arrow in FIG. 3. It is effected for the last data of the selected window, except for the S last symbols, shown in a square rectangle, because it is the side of the window where the probability of finding the transmitted packet is greatest. Subsequently, the actual search phase starts by means of successive correlations between the known header of the packet to be recovered and the selected optimal oversamples.

In accordance with a first variant of the invention, referred to as threshold base variant, the correlations shown by way of shifted blocks with horizontal lines, are realized along the whole window F1 by preferably progressing from a single symbol by correlation until a fixed correlation threshold denoted T has been reached. When this threshold T is reached, the searched packet is supposed to have been found. If the threshold is not reached in the window F1, another window F2 is selected in which the computations of a new optimal sampling instant as well as the correlations are effected similarly as for the first window, and so forth until the searched packet has been recovered, by ensuring that there is a sufficient overlap between the windows. Preferably, the overlap comprises the S added symbols at least of the size of the correlation interval that corresponds at least to the size of the transmitted packet header. The reliability of the threshold base variant is based for a large part on the definition of the threshold T, knowing that the optimal threshold closely depends on the signal-to-noise ratio and the amplitude of the received signal.

In accordance with another variant of the invention, referred to as maximum variant, the correlations are performed for all windows and thus throughout the length of the received packet, irrespective of the result of each correlation so as to finally preserve only the position of the maximum corresponding to the searched packet in the memory, as well as the oversample corresponding to the window in which it is situated. However, this variant necessitates memorization of the optimal sampling instants corresponding to all the computation windows. In spite of this, the maximum variant remains more advantageous than the known methods because the correlations are directly effected on the symbols instead of on the oversamples. Indeed, as the optimal sampling instant has already been computed, the best oversample is then known and it is sufficient to derive the corresponding symbol which has been previously memorized. In the illustrated example, where the oversampling factor is 16 oversamples per symbol, the maximum variant nevertheless allows a reduction of the number of computations by a factor of 16².

In one of the cases described above, where no packet is transmitted in the envisaged time interval, the received packet comprises only noise. In accordance with the threshold base variant and in the hypothesis that the threshold has been correctly defined with respect to the noise in the channel, the result of each correlation must be situated below the fixed threshold so as to come to the conclusion that no packet has been found. In contrast, in accordance with the maximum variant, a maximum will be necessarily obtained and the data of the packet will have to be decoded so as to ascertain that it does not comprise any valid data. To avoid this, it is possible to combine the two methods, i.e. determine the maximum of all the correlations by providing a minimum threshold below which the result is detected to be not valid.

In the other case, which has also been described above, where several packets are transmitted in the same time interval to the network head, two different situations may occur.

In the first situation, the packets overlap. In accordance with the one or the other variant, the position of the first packet must be found and the data have to be decoded so as to ascertain that they are not valid.

In the second situation, the packets are disjunct. In accordance with the threshold base variant, a first threshold indicating the presence of the first packet must be detected first. Subsequently, to be able to detect the other packets, a solution is to continue the process described above by P symbols onwards, i.e. by simply ignoring the P symbols constituting the packet found. The same method can thus be used for all the packets in the interval so as to recover all of them. In accordance with the maximum variant, the method must be applied in successive layers, the first layer allowing detection of the packet having the strongest power and so forth, until the packet having the weakest force. After each detection of a transmitted packet, the P symbols which constitute the detected packet are suppressed or ignored in the subsequent computations so to allow detection of a new maximum.

FIG. 4 shows the different steps of a preferred embodiment of the method as described in FIG. 3 in greater detail, in the ideal case where a single packet is transmitted in a time interval to the receiver. Minor modifications which do not affect the principle will be necessary to take the other cited cases into account when no or, in contrast, several packets are transmitted in the same time interval. The method may be advantageously carried out by means of a computer program in the device, denoted by the reference numeral 22 in FIG. 2. It comprises the following steps, represented by blocks in FIG. 4:

step 40: reception of a data packet comprising D symbols,

step 41: conversion of the received signal at the symbol frequency Fₛ in the baseband,

step 42: oversampling of the signal in the baseband for obtaining M samples per symbol, with M>2,

step 43: low-pass filtering of the oversamples in a period which is equal to DxTₛ where D is the number of symbols in a packet and Tₛ is the duration of a symbol,

step 44: storage of the filtered oversamples in the memory (RAM),

step 45: shifting in the memory of the stored data for selecting a computation window (WIN) comprising P+S symbols in the received packet; during start of the method, the first window is preferably situated at the start of the received packet (thus WIN=F1),

step 45a: a test is performed for determining whether the end of the packet (WIN=end) has been reached, i.e. when at least P+S symbols are found before the end, in this case, the method is ended without the searched packet having been found (KO),

step 46: computation of the optimal sampling instant (OPT) in accordance with an arbitrary known method, performed on the data situated at the end of the previously selected window, except the last S symbols, and selection of the optimal oversample corresponding to this window,

step 47: correlation (CORR) with the known packet header transmitted in a part of the data of the window corresponding to the length of the header and by only taking the symbols into account that correspond to the optimal oversample determined in the previous step, the computation commencing at the start of the computation window,

step 48: test of the result R of the correlation with respect to a fixed decision threshold, denoted T; if the result is higher than the fixed threshold (R>T), the packet has been retrieved (OK), and only the oversample in the previously selected window corresponding to the packet found by correlation is to be selected from the memory, and if not, the method proceeds to the next step,

step 49: shifting of the position of the correlation (CORR+1) in the subsequent data of the window by preferably taking only more than one new symbol,

step 49a: a test to find out if the end of the window has been reached (CORR=end) in which case the method proceeds to step 45 for a shift in the data of the memory so as to select another window having an overlap with the previous window of more than S last symbols, and if not, the method proceeds to step 47 so as to continue the correlations throughout the length of the window, with the exclusion of the last S symbols.

1. A receiver for a packet transmission system of the TDMA type comprising at least a terminal (2) suitable for transmitting, to the receiver (1), a packet of symbols, referred to as transmitted packet, in a time interval allocated in accordance with a predetermined allocation plan, said transmitted packet comprising a useful part and a known header, the receiver comprising:
means (13) for receiving a packet of symbols, referred to as received symbols, corresponding to the allocated time interval,
oversampling means (18) for generating oversamples (S₀ to S_{M-1}) from a received symbol, and
means for recovering said transmitted packet (22) for retrieving the position of the transmitted packet in the allocated time interval, comprising:
shifting means (SELECT) for selecting a variable computing window in the allocated time interval,
means for searching the optimal sampling instant (CAL) for determining, on the basis of the generated oversamples, the optimal oversamples corresponding to the received symbols comprised in the current computing window,
means (CAL) for successively correlating the optimal oversamples in the current computing window with the known header of the transmitted packet, and
decision means (CAL) for detecting the presence and position of the transmitted packet in one of the computing windows as a function of the result of the successive correlations.

2. A receiver as claimed in claim 1, wherein the computing window comprises a plurality of symbols which is higher than the size of the transmitted packet, the difference in number of symbols being provided for mitigating an ambiguity related to the correlation results.

3. A receiver as claimed in claim 2, wherein the optimal sampling instant is searched on the basis of received symbols situated at the end of the current window, except for the last symbols corresponding in number to said difference.

4. A receiver as claimed in claim 1, wherein the successive correlations increment by at most one symbol between each correlation.

5. A packet transmission system of the TDMA type comprising at least a transmitter (2) and a receiver (1), the transmitter being suitable for transmitting to the receiver a packet of symbols referred to as transmitted packet comprising a useful part and a known header in time intervals allocated in accordance with a predetermined allocation plan, the receiver comprising:
means (13) for receiving a packet of symbols, referred to as received symbols, corresponding to the allocated time interval,
oversampling means (18) for generating oversamples (S₀ to S_{M-1}) from a received symbol, and
means for recovering said transmitted packet (22) for retrieving the position of the transmitted packet in the allocated time interval, comprising:
shifting means (SELECT) for selecting a variable computing window in the allocated time interval,
means for searching the optimal sampling instant (CAL) for determining, on the basis of the generated oversamples, the optimal oversamples corresponding to the received symbols comprised in the current computing window,
means (CAL) for successively correlating the optimal oversamples in the current computing window with the known header of the transmitted packet, and
decision means (CAL) for detecting the presence and position of the transmitted packet in one of the computing windows as a function of the result of the successive correlations.

6. A receiving method for determining the position of a packet of symbols, referred to as transmitted packet, the system comprising useful data and a known header transmitted by a terminal of a packet transmission system of the TDMA type within a time interval allocated in accordance with a predetermined allocation plan, the method comprising the steps of:
receiving (40) a packet, referred to as received packet, corresponding to the allocated time interval and comprising symbols, referred to as received symbols, among which is the transmitted packet,
oversampling (42) for generating oversamples from said received symbols,
shifting for selecting a variable computing window in the received packet,
searching the optimal sampling instant (46) for selecting, on the basis of the generated oversamples, the optimal oversamples corresponding to the received symbols comprised in the current window, and
successive correlations (47) in the current window between the selected oversamples and the known header of the transmitted packet, and
decision (48) for detecting the presence of the transmitted packet in a computing window and for deriving its position within the allocated time interval.

7. A method as claimed in claim 6, wherein the decision step effects a detection of the threshold for each correlation result so as to derive the presence and position of the transmitted packet.

8. A method as claimed in claim 6, wherein the decision step effects a maximum computation between all the results of the successive correlations so as to derive the presence and position of the transmitted packet.

9. A computer program for a receiver, the computer program comprising instructions which, once loaded into the receiver, enable it to perform the method as claimed in claim 6.

10. A signal for transporting a computer program, the program comprising instructions for performing the method as claimed in claim 6.
